(19) United States
(12) Patent Application Publication
(10) Pub. No.: US 2003/0177974 A1
(43) Pub. Date: Sep. 25, 2003

(54) Lock Indicator

(75) Inventor: Christer Gustav Dominique, Torslanda (SE)

Correspondence Address: FORD GLOBAL TECHNOLOGIES, LLC., SUITE 600 - PARKLANE TOWERS EAST, ONE PARKLANE BLVD., DEARBORN, MI, 48126, US

(73) Assignee: FORD GLOBAL TECHNOLOGIES, L.L.C., Dearborn, MI (US)

(21) Appl. No.: 10/249,159

(22) Filed: Mar. 19, 2003

(30) Foreign Application Priority Data
Mar. 19, 2002 (EP) 01006149.5

(51) Int. Cl. G08B 1/00

(52) U.S. Cl. 116/200; 49/503; 292/45; 70/264

(57) ABSTRACT

The invention relates to a vehicle door lock indicator device which is arranged to be moved between at least a first position and a second position. Said vehicle door lock indicator device includes an actuator, substantially made of shape memory alloy (SMA). The actuator is arranged for effecting the movement of the vehicle door lock indicator device between at least a first position and a second position. The invention also relates to a vehicle and a vehicle door system having a vehicle door lock indicator device as described above.

### BACKGROUND OF INVENTION

1. Field of the Invention

The invention relates to a vehicle door lock indicator device.

2. Technical Background

Vehicle door lock indicators are well known in the art. Typically, vehicle door lock indicators are manually movable lock knobs for e.g. locking and unlocking a vehicle door. The lock indicators are often mechanically connected to a latch mechanism forming part of a vehicle door system. When the latch is in an unlatched state the vehicle door may be opened. The opening can be achieved by pulling and moving the lock indicator from a first position where the latch is engaged to a second position where the latch is disengaged and the door may be opened. Since such vehicle door lock indicator devices often are mechanically connected to the latch mechanism a considerable amount of space is occupied in the vehicle door by such a vehicle door system. Due to various reasons, e.g. safety it is desirable to provide more space in the vehicle door for other applications.

Another issue with many lock indicators is that their position by the vehicle door often makes them quite difficult to reach for a person sitting in the vehicle. Furthermore, such conventional lock indicators have to be grabbed and pulled in order for a passenger to unlock the vehicle door. Due to these and other reasons many people, e.g. elderly or handicapped people, experiences difficulties when trying to pull the lock indicator from the first to the second position.

There are also high demands on vehicle door locks and vehicle door systems regarding for example accurate response time, durability, robustness, reliability, break in resistance, and function during extreme loading that still needs to be resolved.

It is thus desirable for many reasons to provide a simple construction for these kinds of lock indicators/systems, which provides for high reliability.

### SUMMARY OF INVENTION

The object of the present invention is to provide a vehicle door lock indicator device that overcomes the above issues and, when installed, occupies a limited amount of space in the vehicle door.

Furthermore it is desirable to provide a vehicle door lock indicator device and a vehicle door system with high standards regarding durability, robustness, break in resistance, and functionality during extreme loading.

According to a first aspect of the invention there is provided a vehicle door lock indicator device which is arranged to be moved between a first position and a second position, wherein the vehicle door lock indicator device comprises an actuator, substantially made of shape memory alloy (SMA), for effecting the movement of the vehicle door lock indicator device between the first and second positions.

The rugged design with few components makes a vehicle door lock indicator device according to the invention reliable, robust and also easy to manufacture and install in a vehicle. An actuator made of shape memory alloy has quick response time, which is important in situations e.g. when fast locking of a vehicle is of importance. Preferably, at least one controller is arranged together with the actuator in order to control the motion between the first and second positions.

According to a further preferred embodiment of the invention the controller is a flipper, comprising a claw and a pawl. By this arrangement it is possible to obtain a lock indicator, which is movable between a first and a second position by a gentle push. Thus, there is provided a lock indicator which can be operated manually without need for grabbing and dragging the lock indicator to a second position. It is realized that also other solutions, for controlling the movement of the vehicle door lock indicator device, can be used together with the actuator comprising shape memory alloy. Conveniently, the lock indicator can be operated electronically and be activated from a control panel.

According to a preferred embodiment of the invention said vehicle door lock indicator device, when being actuated, provides a signal to a vehicle door system. This arrangement provides for a vehicle door system with electrical or remote connection between the components of the vehicle door system. By the possibility to avoid mechanical connections between components of the vehicle door system, such as between a door lock indicator and a latch assembly or a key hole etc. more space can be made available for other installations. Thus, the resulting vehicle door system according to the invention will also be easy to manufacture and install.

Preferably, said actuator comprises at least one member of shape memory alloy (SMA). A thin cross-section and the simple construction of the shape memory alloy member actuator provides quick response time under normal conditions. The quick response time derives from a possibility of fast heating and cooling of the shape memory alloy member. It is realized that the significant surface area of the shape memory alloy member provides for especially a fast cooling step.

Accordingly a further preferred embodiment of the actuator of shape memory alloy (SMA) has at least one back-up member of shape memory alloy (SMA) for providing additional force under extreme conditions. The back-up member has a cross section area that is preferably between 4 and 25 times greater than a shape memory alloy member in the vehicle door lock indicator device in question. This arrangement provides a reliable and powerful door lock indicator that enables a vehicle door to be e.g. unlocked and opened even during extreme loading.

According to a second aspect of the invention it is also provided a vehicle door system comprising a vehicle door lock indicator device arranged to be moved between at least a first position and a second position, wherein the vehicle door lock indicator device is made of an actuator, substantially made of shape memory alloy (SMA), for effecting the movement of said lock indicator between the first and second positions. The actuator is preferably connectable to an energy source.

Preferably, the vehicle door system comprises a latch assembly and a control unit for controlling said vehicle door system. More preferably, the latch assembly and the control unit are electronically interconnected, without need for mechanical interconnection between components of the vehicle door system. This arrangement will provide for a vehicle door system, which is easy to install but does not require additional space, for mechanical interconnections, within the vehicle door. Hence, more space will be available for safety equipment and other arrangements.

Furthermore, the layout of the vehicle door system according to a second preferred embodiment of the invention makes it possible to use highly sophisticated solutions for locking and unlocking the vehicle. Suitably, the control unit comprises a locking and unlocking logic for the vehicle door system. Preferably, the control unit may be activated, especially from the outside, by a key or key fob. From the inside of the vehicle the vehicle door lock indicator device is suitably used for locking and unlocking a vehicle door.

The interconnection between components of the vehicle door system can be accomplished by wireless connection. Another way of enabling the interconnection between components of the vehicle door system is by cables, through which signals to the components may be transmitted. According to a preferred embodiment of the invention said key or key fob has wireless connection to said control unit for transmitting information to the vehicle door system.

It is realized that a vehicle door system according to the invention can be controlled at a very detailed level, since it allows for each component to be individually controlled. This will add significant break-in resistance to a vehicle with such a system. Physical damage to or obstruction of a single component of the vehicle door system will then not have any direct physical impact on other components of the vehicle door system, since each component of the vehicle door system can be made mechanically isolated from the other and controlled individually. It will not be sufficient to e.g. manipulate a key hole in order to unlock the vehicle. A vehicle door system according to the invention is not even necessarily provided with a conventional key hole.

As mentioned above it is realized that the door system can be controlled in a highly sophisticated manner, since the system allows for separate control of individual components of the system. There are a number of possible combinations of individual conditions of the door system components for such a system, of which some preferred conditions will be given in the following. These conditions are only indicated by way of example and it is realized that the door system according to the invention enables further ways of controlling a door.

Preferably, the latch assembly is set in a latched condition, and the vehicle door, being in a closed position, is set in a locked or lockable state by said control unit, when said vehicle door lock indicator device is in said first position.

Another preferred condition of the door system is enabled according to the invention, wherein said vehicle door lock indicator device is actuated and said latch assembly is set in an unlatched state, and said vehicle door, being set in an unlocked state, may be opened, when said vehicle door lock indicator device is in said second position.

Preferably, the control unit will receive a control signal from a component in the system before the next action of the system take place. if the control signal is not received or indicates that something is wrong the vehicle can remain locked or even become locked. This arrangement results in high break-in resistance without demanding a lot of space compared to prior art constructions.

Preferably, a vehicle door lock indicator device is arranged by each door of a vehicle. A vehicle provided with the inventive vehicle door lock indicator device and/or vehicle door system has increased space for necessary safety equipment and also present an easy, reliable and safe locking and unlocking function to the vehicle door.

The vehicle door lock indicator device is especially intended for vehicle doors but thanks to its rugged design and limited space keeping it can be suitable for other types of lock indicators as well.

### BRIEF DESCRIPTION OF DRAWINGS

Currently preferred embodiments of the present invention will now be described in more detail, with reference to the accompanying drawings.

FIG. 1a is a section view of a vehicle door lock indicator device, according to a first embodiment of the invention, in a first position.

FIG. 1b is a section view of a vehicle door lock indicator device, according to a first embodiment of the invention, in a second position.

FIG. 2 is a section view of a vehicle door lock indicator device, according to an alternative first embodiment of the invention, in a first position.

FIGS. 3a-3d discloses a preferred alternative first embodiment of the invention in a perspective and a sectional view respectively.

FIG. 4 schematically illustrates a vehicle door system according to a second aspect of the invention.

FIG. 5 schematically illustrates a vehicle door system according to a further preferred embodiment of the second aspect of the invention.

FIG. 6 is a perspective view of an example of a vehicle appropriate for a lock indicator device according to an embodiment of the invention.

### DETAILED DESCRIPTION

A first embodiment of the invention related to a vehicle door lock indicator device will now be described by way of example in the following with reference to the accompanying drawings.

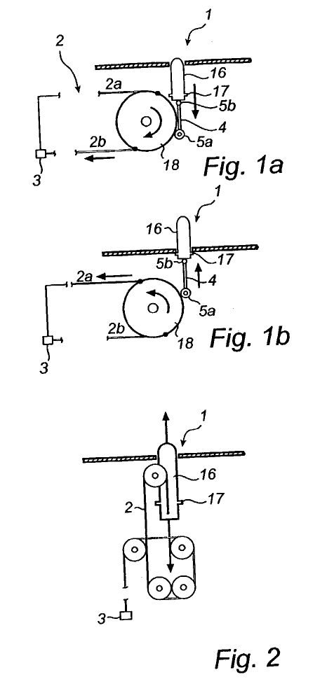

With reference to FIGS. 1a and 1b, a first embodiment of a vehicle door lock indicator device 1 is disclosed by way of example. A door lock knob 16 is operatively connected to one actuator 2 having two SMA members 2a, 2b. Hence, said actuator 2 is substantially made of shape memory alloy (SMA) and arranged to be powered by an energy source 3. The lock knob 16 is operatively connected to a pivotal controller 18 by a hinged pin 4. The hinged pin 4 has a joint connection 5a to the controller 18 and a joint connection 5b to the lock knob 16. Both SMA members 2a, 2b are arranged to the pivotal controller 18. The function will be described more in detail in a further section.

An actuator to be used in connection with the invention is substantially made of shape memory alloy (SMA). In the preferred embodiment the actuator comprises at least one SMA member. Depending on the forces on the vehicle door lock indicator device 1 and the SMA member used it is understood that the diameter may be varied. For use in a vehicle door under normal conditions the thickness interval of between 10 μm and 1 mm, preferably between 10 μm and 100 μm for the SMA member used as actuator is appropriate. This thickness will give an appropriate response and cycle time, which is essential for this kind of applications. It is hence preferred to use additional SMA members in order to provide more force rather than increase the dimension of an individual SMA member. By the inventive vehicle door lock indicator device 1, around 20 cycles per minute can be accomplished. According to the preferred embodiment the SMA member used is a thin wire with an essentially circular cross section shape. Other shapes of the SMA member cross section are possible.

Vehicles sometimes experience significant violence resulting in extreme loading on at least parts of the vehicle. In order to control the vehicle door lock indicator device 1 in extreme conditions the vehicle door lock indicator device 1 has at least one back-up member for providing additional force in extreme conditions.

The back-up member has a cross-sectional area that is preferably between 4 and 25 times greater than a shape memory alloy member in the vehicle door lock indicator device 1 in question. The back-up member, when activated, will, need more power to actuate the vehicle door lock indicator device but will also add significant force compared to normal operational conditions and hence the extreme control conditions can be fulfilled. The response time of the vehicle door lock indicator device 1 in extreme control condition can be longer than in the normal operational conditions.

There are at least two factors making SMA members appropriate for use as actuators. They undergo a phase deformation, changing the crystalline structure of the material, from the Martensite phase to the Austenite phase in a relatively low temperature range. An SMA member can “remember” its previous shape after having been plastically deformed. If a sample, being in its low temperature phase (Martensite), is plastically deformed to a new shape it will return to its original shape when heated to its high temperature phase (Austenite). Since the modulus of elasticity and yield stress are much higher in the Austenite phase it will not only return to its original shape, but when doing so, also produce a force much higher than required for deformation. The difference in deformation force and recovery force can be used for actuation. The original shape is “taught” to the material by forming and fixing it to the desired shape, followed by heating to a temperature much higher than any normal operational temperature. Normally a sufficient heat treatment for shape memory “teaching” is around 500° C. and lasts for a few minutes. As mentioned the characteristics of SMA members change dramatically when the temperature is increased. In the materials appropriate for actuation the modulus of elasticity is normally more than doubled and the yield stress more than four times higher, when the material is heated above its transformation temperature. The changes are reversible and fully reproducible. The heating of the SMA member is conveniently done using Ohmic heating, that is by letting current pass through the material, wherein the electric resistance of the material causes a temperature increase.

There are various Shape Memory Alloys suitable for use in an embodiment of the present invention. Nitinol is an example of such a Shape memory alloy. Nitinol is a corrosion resistant, super elastic Nickel-Titanium alloy. Being super elastic, Nitinol can be stretched up to 10% without rupturing. When contracting, it can produce an actuation stress of more than 600 MPa in extreme cases, but should normally not be subjected to more than 170 MPa. Furthermore, when stretched less than 5%, Nitinol is also fatigue persistent. Required electric potential for power supply is normally a few volts. The temperature characteristics for the phase change is highly dependent on the content ratio of the alloy components. There exist in addition to various types of Nitinol also for example Fe-based and Cu-based shape memory alloys. Given the above data it is understood by a man skilled in the art of vehicle door lock indicator devices 1 that the length of the SMA members is an important design tool in order to provide a long-lasting and reliable vehicle door lock indicator device.

Now, referring again to FIGS. 1a,b the function of a first embodiment of the vehicle door lock indicator device according to a first aspect of the invention will be described. The pivotally mounted controller 18 has two shape memory alloy members 2a, 2b connected thereto. One shape memory alloy member 2a is arranged at the top of the controller 18 and another shape memory alloy member 2b is arranged at the bottom of the same controller. When the current is applied to one of the SMA members 2a, 2b, respectively, the SMA member 2a, or 2b shrinks due to the rise in temperature in the respective SMA member. This deformation generates a force resulting in a movement of the lock knob 16. In FIG. 1a the current is applied to the below arranged SMA member 2b, which has initiated a motion downwards of the lock knob 16 to the first position. This is further illustrated by the arrows in the figure. In FIG. 1b the current is applied to the above arranged SMA member 2a, which has initiated a motion of the lock knob 16 to the second position. The initiated pivotal movement of the controller 18 is indicated by an arrow in FIGS. 1a and 1b. Based on the position of the lock knob 16 a signal comprising information to a vehicle door system may be transmitted. The lock knob 16 is also manually movable between said first and second positions. During such a motion a switch (not shown) is triggered for providing current to the corresponding SMA member 2a and 2b, respectively, in order to control the motion of the vehicle door lock indicator device 1 and provide a signal to the vehicle door system.

Now, referring to FIG. 2, wherein an alternative embodiment according to the first aspect of the invention is disclosed. Most features are common with the first described embodiment and therefore not described again in detail. An actuator 2 includes shape memory alloy is arranged to the vehicle door lock indicator device 1. The actuator 2 describes a path with a suitable length for achieving the desired motion of the lock knob 16. The lock knob 16 is shown in the first position from which the lock knob 16 is movable either manually by pulling the lock knob upwards or by means of electric actuation of the actuator 2. It is realized that one additional SMA-member can be arranged to the lock knob in order to achieve a motion in both ways. This is schematically indicated by arrows in FIG. 2. A stopper 17 is advantageously provided on the lock knob 16 to reduce the risk of damage, e.g. if the lock knob is being heavily pulled. Although not shown in the drawings it is known to make the head of a lock knob wider. This will reduce the risk for damage if the lock knob is being heavily pushed.

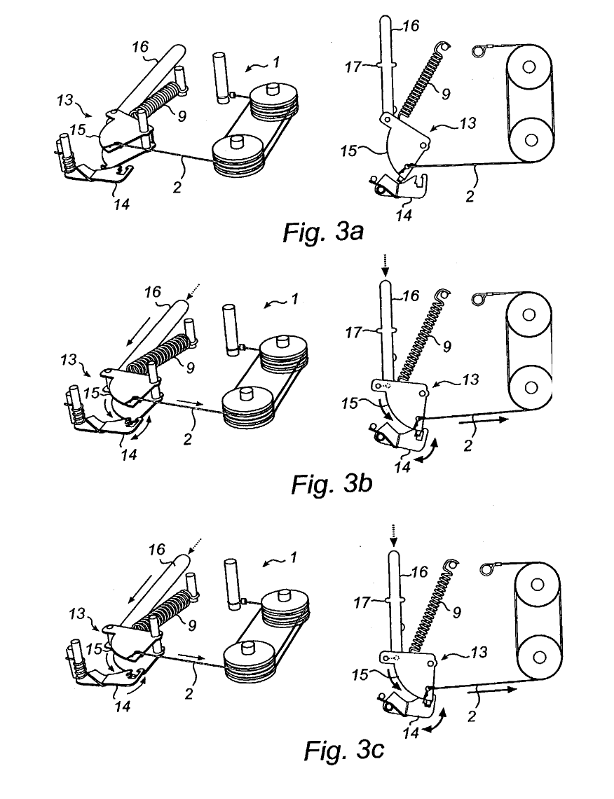

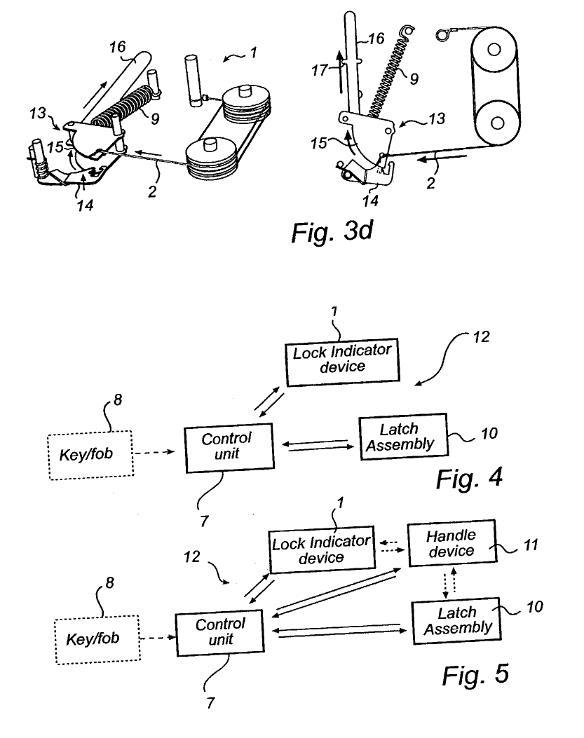

In FIGS. 3a-3d a further preferred embodiment of the first aspect of the invention is disclosed. Compared to prior described alternative embodiments this vehicle door lock indicator device 1 includes a flipper 13. The flipper 13 is pivotally arranged to the vehicle door lock indicator device 1 and operatively connected to a lock knob 16. A spring 9, for providing return force to the vehicle door lock indicator device 1, is arranged in one end to the flipper 13. The flipper 13 mainly consists of a claw 14 and a pawl 15. The lock knob 16 is provided with a stopper 17. In FIG. 3a the lock knob is in the second position. When the lock knob 16 is moved to the first position, wherein the motion is activated by a gentle push on the lock knob 16, the claw 14 engages with the pawl 15 just before the actuator 2 is fully shrunk. This is shown in FIG. 3b. When the lock knob 16 is in the first position and is actuated by a gentle push or click, the actuator 2 continues the pulling operation and during this further motion the claw 14 is adapted to release the pawl 15. This is conveniently accomplished by providing a slope at one side of the bottom of the mouth of the claw 14, as indicated in FIG. 3c. Since the shape memory alloy of the actuator 2 cools rapidly the lock knob 16 will quickly resume to the second position. The spring 9 is arranged to add force in order to control the motion in this step. This is further illustrated in FIG. 3d.

Now referring to FIG. 4, wherein a vehicle door system 12 according to a second aspect of the invention is illustrated schematically. Since the vehicle door lock indicator device 1 has the advantage of allowing for an electric system, it is understood that said actuator 2 is well equipped to be activated by a control unit 7. The control unit 7 preferably also controls a latch assembly 10 of the vehicle door system 12.

Preferably, the control unit 7 is used for controlling the period of time during which the door lock knob 16 is held in the second position. After that period, if not further activated, the lock knob 16 will resume the first position. Furthermore, the control unit 7 can be given a threshold value for the maximum of allowable repeated motions, between the first and second position of the lock knob 16, during a time interval, in order to reduce the risk for overheating caused by e.g. “playing”.

The control unit 7 is, preferably, but not necessarily provided with a receiver (not shown) that will react on a signal transmitted from the vehicle door lock indicator device 1. Suitably, the control unit 7, has a wireless connection with a key or a key fob 8. The locking and unlocking logic may be provided at least partly in the key or key fob 8.

The procedure to unlock and open a closed and locked vehicle door with a vehicle door system 12 according to a second aspect of the invention, including a vehicle door lock indicator device 1, will now be described. When activated, the vehicle door lock indicator device 1 sends a signal to the control unit 7. When the actuated vehicle door lock indicator device 1 is moved from the first to the second position, the control unit 7 activates the locking and unlocking logic. The vehicle door will become unlocked, the latch assembly 10 unlatched and the vehicle door may be opened.

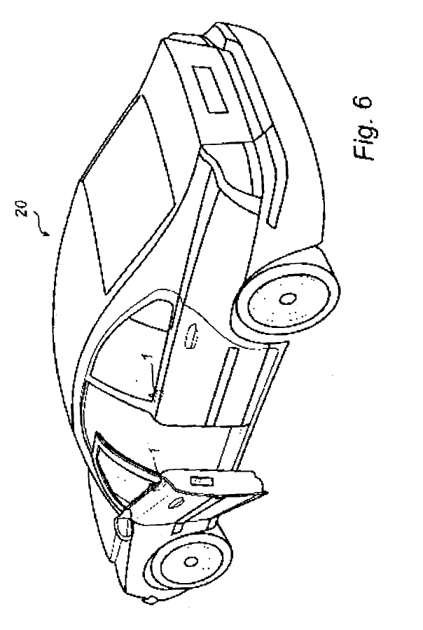

Referring to FIG. 5, wherein the vehicle door system 12 according to a further preferred embodiment of the second aspect of the invention is presented. In addition to the first described embodiment of the second aspect of the invention the vehicle door system 12 further comprises a handle device 11 The control unit 7 controls the vehicle door-lock indicator device 1, the handle device 11 and the latch assembly 10. According to the further preferred embodiment the control unit 7 controls these devices by sending and receiving signals. The vehicle door lock indicator device 1, the handle device 11 and the latch assembly 10 are able to transmit information within the vehicle door system 12 in combination with the transmitted information from the control unit 7.

It is also an object of the present invention to provide a vehicle 20, comprising at least one vehicle door lock indicator device 1 according to the invention. Preferably, the vehicle is provided with an embodiment of the inventive vehicle door system 12. Such vehicle 20 will have considerable space for safety arrangements in the sides of the vehicle. Other resulting benefits will be apparent from the above given description. A vehicle 20 according to a preferred embodiment of the invention is shown in FIG. 6. The vehicle door lock indicator device 1 and the vehicle door system 12 of the vehicle 20 are well adapted to be used as a part of a central locking system.

The present invention should not be considered as being limited to the abovedescribed embodiments, but rather includes all possible variations covered by the scope defined by the appended claims. It is understood by a man skilled in the art that the exact shape of the components and members of the vehicle door lock indicator device 1 can be varied in order to achieve alternative embodiments of the invention. Especially, the different states of the vehicle door system during actuation can be varied due to the flexibility of the vehicle door system enabled by the invention.

According to a preferred embodiment a local accumulator is used as the energy source 3. it is understood by a person skilled in the art that a central energy source can be used to provide the vehicle door lock indicator device 1 with power. It is of course important to create a reliable power system to the vehicle door lock indicator device 1. Hence, a central and local energy source system working together would be appropriate for this invention. However, the exact manner, in which power is supplied to the vehicle door lock indicator device 1 is not crucial for the present invention.

1. A vehicle door lock indicator device which is arranged to be moved between at least a first position and a second position wherein the vehicle door lock indicator device comprises: an actuator, substantially made of shape memory alloy (SMA), for effecting the movement of said vehicle door lock indicator device between said at least first and second positions.

2. The vehicle door lock indicator device according to claim 1, wherein said actuator is connectable to an energy source.

3. The vehicle door lock indicator device according to any one of claim 1, wherein said vehicle door lock indicator device, when being actuated, provides a signal to a vehicle door system.

4. The vehicle door lock indicator device according to claim 1, wherein said actuator comprises at least one member of shape memory alloy (SMA).

5. The vehicle door lock indicator device according to claim 1, wherein said actuator has at least one back-up member of shape memory alloy (SMA) for providing additional force under extreme conditions.

6. The vehicle door lock indicator device according to claim 1, wherein said vehicle door lock indicator device comprises a flipper being operatively connected to said actuator.

7. The vehicle door lock indicator device according to claim 1, wherein said lock indicator is a lock knob.

8. The vehicle door lock indicator device according to claim 7, wherein said lock knob includes a stopper.

9. A vehicle door system comprising a vehicle door lock indicator device arranged to be moved between at least a first and a second position wherein the vehicle door lock indicator device comprises an actuator substantially made of shape memory alloy (SMA), for effecting the movement of said vehicle door lock indicator device between said at least first and second positions.

10. The vehicle door system according to claim 9, wherein said actuator is connectable to an energy source.

11. The vehicle door system according to claim 9, wherein said vehicle door system comprises a latch assembly and a control unit for controlling said vehicle door system.

12. The vehicle door system according to claim 11, wherein said control unit comprises a locking and unlocking logic for the vehicle door system.

13. The vehicle door system according to claim 11, wherein said latch assembly is set in a latched condition, and the vehicle door, being in a closed position, is set in a locked or lockable state by said control unit, when said vehicle door lock indicator device is in said first position

14. The vehicle door system according to claim 11, wherein said latch assembly is set in an unlatched state, and said vehicle door, being set in an unlocked state, may be opened, when said vehicle door lock indicator device is in said second position.
